(19) United States
(12) Patent Application Publication
(10) Pub. No.: US 2024/0389147 A1
(43) Pub. Date: Nov. 21, 2024

(54) WIRELESS COMMUNICATION METHOD, WIRELESS COMMUNICATION SYSTEM, AND CONTROL PROGRAM CAUSING COMPUTER TO EXECUTE WIRELESS COMMUNICATION METHOD

(71) Applicant: NIPPON TELEGRAPH AND TELEPHONE CORPORATION, Tokyo (JP)

(72) Inventors: Shoko SHINOHARA, Musashino-shi, Tokyo (JP); Yusuke ASAI, Musashino-shi, Tokyo (JP); Yasushi TAKATORI, Musashino-shi, Tokyo (JP); Junichi IWATANI, Musashino-shi, Tokyo (JP); Yoshitaka SHIMIZU, Musashino-shi, Tokyo (JP); Tomoyuki YAMADA, Musashino-shi, Tokyo (JP)

(73) Assignee: NIPPON TELEGRAPH AND TELEPHONE CORPORATION, Tokyo (JP)

(21) Appl. No.: 18/691,460

(22) PCT Filed: Oct. 1, 2021
(86) PCT No.: PCT/JP2021/036462

§ 371 Date: Mar. 13, 2024

(51) Int. Cl. H04W 74/0816; H04W 52/02; H04W 72/121; H04W 84/12

(52) U.S. Cl. CPC H04W 74/0816; H04W 72/121; H04W 52/0206; H04W 84/12

(57) ABSTRACT

In a wireless communication method between a base station and a plurality of wireless terminals, the base station includes a plurality of first wireless modules that perform wireless communication using different channels that do not overlap each other, and each of the plurality of wireless terminals includes a second wireless module that performs wireless communication using any one communication channel. The wireless communication method includes executing a channel switching process of switching use states of the plurality of first wireless modules according to a predetermined schedule so as to enable any one of the plurality of first wireless modules to carry out transmission and to prohibit the other thereof from carrying out transmission. Further, there is a sleeping of an operation of the second wireless module while the first wireless module that performs wireless communication using the communication channel is prohibited from carrying out transmission.

### TECHNICAL FIELD

The present disclosure relates to a wireless communication system that switches between a plurality of channels to perform wireless communication.

### BACKGROUND ART

A wireless communication system composed of a base station and wireless terminals is known. A representative example of the wireless communication system is a wireless local area network (LAN) for public use. In a wireless LAN for public use, for example, a use case in which data is transmitted from a base station to a wireless terminal such as a computer terminal or a smartphone terminal is assumed. Further, with the widespread of Internet of Things (IoT) terminals in recent years, there has been an increase in use cases of transmitting data from the wireless terminal side to the base station.

In relation to wireless communication for the IoT, the use of the unlicensed Sub-1 GHz band has been institutionalized in many countries around the world (see NPL 1 and NPL 2). In Japan, the 920 MHz band is allocated as the frequency band for electronic tag systems. For example, wireless communication systems for a low power wide area (LPWA) such as LoRa (registered trademark) and WiSUN (registered trademark) are known as active electronic tag systems. In addition, the use of IEEE 802.11ah which is one wireless LAN standard is also being considered.

Since the number of frequency channels is limited in the 920 MHz band, cases in which wireless communication is performed while changing the channels to be used can also be considered.

For example, in Japan, there is a limit on the total transmission time during the use of the 920 MHz band, and the total transmission time per hour needs to be within 360 seconds. Since wireless communication devices limit data transmission to comply with this total transmission time, throughput is also limited. However, a total transmission time of 360 seconds for each channel per hour, up to 720 seconds in total, is allowed for the housing of a wireless communication device that switches between two non-overlapping channels. Thus, in order to improve throughput, performing wireless communication while changing the channels used by the housing of the wireless communication device can be considered.

### Citation List

### Non Patent Literature

[NPL 1] “Radio equipment standard standards for 920 MHz band telemeter, tele-control, and data transmission,” Association of Radio Industries and Businesses, ARIB STD-T108 Version 1.3, Apr. 12, 2019
[NPL 2] “IEEE Standard for Information technology—Telecommunications and information exchange between systems Local and metropolitan area networks-Specific requirements, Part 11: Wireless LAN Medium Access Control (MAC) and Physical Layer (PHY) Specifications, Amendment 2: Sub 1 GHz License Exempt Operation,” IEEE Computer Society, IEEE Std 802.11ah TM-2016, 7 Dec. 2016.

### [Summary of Invention][Technical Problem]

Downlink traffic increases as the number of wireless terminals connected to one base station increases. For this reason, particularly for downlink traffic, there is a need to reduce the total transmission time by switching between a plurality of channels to perform wireless communication. In addition, when the number of wireless terminals that perform wireless communication using one channel is large, there may be concern that frame collisions between uplink traffic of wireless terminals increase and throughput decreases in the case of access control using carrier-sense multiple access with collision avoidance (CSMA/CA) or the like.

On the other hand, considering control overhead, feasibility, or the like in a case where the number of wireless terminals is large, it is desirable that each of the wireless terminals does not require an additional control device and control function when wireless communication is performed by switching between a plurality of channels.

One object of the present disclosure is to provide a technique that makes it possible to reduce the total transmission time for downlink traffic without requiring an additional control device and control function in each wireless terminal. Another object of the present disclosure is to provide a technique that makes it possible to reduce frame collisions between uplink traffic of wireless terminals.

### Solution to Problem

A first aspect relates to a wireless communication method between a base station and a plurality of wireless terminals forming a wireless communication network with the base station.

The base station includes a plurality of first wireless modules that perform wireless communication using different channels that do not overlap each other. Each of the plurality of wireless terminals includes a second wireless module that performs wireless communication using any one of the communication channels.

The wireless communication method according to the first aspect includes: executing a channel switching process of switching use states of the plurality of first wireless modules according to a predetermined schedule so as to enable any one of the plurality of first wireless modules to carry out transmission and to prohibit the other thereof from carrying out transmission; and sleeping an operation of the second wireless module while the first wireless module that performs wireless communication using the communication channel is prohibited from carrying out transmission in the schedule for each of the plurality of wireless terminals.

A second aspect relates to a wireless communication method between a base station and a plurality of wireless terminals forming a wireless communication network with the base station.

The base station includes a plurality of first wireless modules that perform wireless communication using different channels that do not overlap each other. Each of the plurality of wireless terminals includes a second wireless module that performs wireless communication using any one of the communication channels.

The wireless communication method according to the first aspect includes: executing a channel switching process of switching use states of the plurality of first wireless modules according to a predetermined schedule so as to enable any one of the plurality of first wireless modules to carry out transmission and to prohibit the other thereof from carrying out transmission; and causing each of the plurality of wireless terminals not to request a response frame from the base station during transmission of a frame.

A third aspect relates to a wireless communication system. The wireless communication system according to the third aspect includes: a base station; a plurality of wireless terminals configured to form a wireless communication network with the base station; and a control device configured to control the base station.

The base station includes a plurality of first wireless modules that perform wireless communication using different channels that do not overlap each other. Each of the plurality of wireless terminals includes a second wireless module that performs wireless communication using any one of the communication channels.

The control device executes a channel switching process of switching use states of the plurality of first wireless modules according to a predetermined schedule so as to enable any one of the plurality of first wireless modules to carry out transmission and to prohibit the other thereof from carrying out transmission. The base station notifies the plurality of wireless terminals of the schedule.

Each of the plurality of wireless terminals is configured to sleep an operation of the second wireless module while the first wireless module that performs wireless communication using the communication channel is prohibited from carrying out transmission in the schedule.

A fourth aspect relates to a wireless communication system. The wireless communication system according to the fourth aspect includes: a base station; a plurality of wireless terminals configured to form a wireless communication network with the base station; and a control device configured to control the base station.

The base station includes a plurality of first wireless modules that perform wireless communication using different channels that do not overlap each other. Each of the plurality of wireless terminals includes a second wireless module that performs wireless communication using any one of the communication channels.

The control device executes a channel switching process of switching use states of the plurality of first wireless modules according to a predetermined schedule so as to enable any one of the plurality of first wireless modules to carry out transmission and to prohibit the other thereof from carrying out transmission.

Each of the plurality of wireless terminals is configured not to request a response frame from the base station during transmission of a frame.

A fifth aspect relates to a control program which is executed by a computer.

The control program according to the fifth aspect causes the computer to execute the wireless communication control method according to the first or second aspect.

### Advantageous Effects of Invention

According to the present disclosure, it is possible to switch transmission from the base station to the wireless terminal among a plurality of channels and to reduce the total transmission time for downlink traffic. In particular, this can be realized without requiring an additional control device and control function for each of a plurality of wireless terminals.

Further, according to the present disclosure, the plurality of wireless terminals are distributed in groups that perform wireless communication using communication channels different from each other. This makes it possible to reduce frame collisions between uplink traffic of each of a plurality of wireless terminals.

### BRIEF DESCRIPTION OF DRAWINGS

FIG. 1 is a block diagram conceptually illustrating a configuration of a wireless communication system according to a first embodiment.

FIG. 2 is a conceptual diagram illustrating an example of wireless communication using a wireless communication method realized by the wireless communication system according to the first embodiment.

FIG. 3 is a diagram conceptually illustrating an example of frame collision.

FIG. 4 is a block diagram illustrating a configuration of a base station according to the first embodiment.

FIG. 5 is a block diagram illustrating a configuration example of a control device according to the first embodiment.

FIG. 6 is a flowchart illustrating processing executed in a first example of connection destination control.

FIG. 7 is a flowchart illustrating processing executed in a second example of connection destination control.

FIG. 8 is a flowchart illustrating processing executed in a third example of connection destination control.

FIG. 9 is a flowchart illustrating processing executed in a fourth example of connection destination control.

FIG. 10 is a conceptual diagram illustrating an example of an operation of a first wireless module in a base station according to a modification example.

FIG. 11 is a conceptual diagram illustrating an example of wireless communication using a wireless communication method realized by a wireless communication system according to a second embodiment.

FIG. 12 is a conceptual diagram illustrating an example of wireless communication using a wireless communication method realized by a wireless communication system according to modification example 2 of the second embodiment.

### DESCRIPTION OF EMBODIMENTS

Embodiments of the present disclosure will be described with reference to the accompanying drawings.

### 1. First Embodiment

### 1-1. Overview

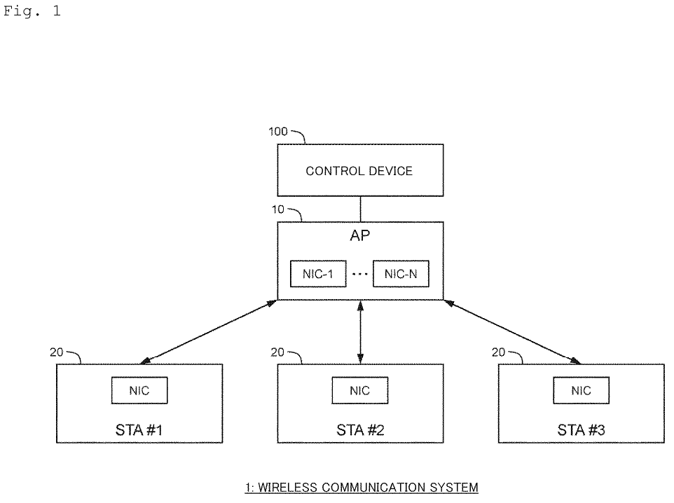

FIG. 1 is a block diagram schematically illustrating a configuration of a wireless communication system 1 according to a first embodiment. The wireless communication system 1 includes a base station (AP) 10 and a plurality of wireless terminals (STA) 20 that form a wireless communication network with the base station 10. The base station 10 and the plurality of wireless terminals 20 communicate wirelessly with each other.

For example, the wireless communication system 1 is a wireless LAN system, and the base station 10 is an access point for wireless LAN. A cell composed of the access point and the plurality of wireless terminals 20 is referred to as a basic service set (BSS).

The wireless communication system 1 performs wireless communication using, for example, the unlicensed Sub-1 GHZ band. For example, the wireless communication system 1 performs wireless communication using the 920 MHz band.

In the wireless communication system 1 according to the first embodiment, the base station 10 is configured to be able to perform wireless communication using a plurality of channels (frequency channels). On the other hand, each of the plurality of wireless terminals 20 is configured to perform wireless communication using any one channel.

According to the first embodiment, wireless communication between the base station 10 and the wireless terminal 20 uses a wireless module. That is, the base station 10 and the wireless terminal 20 include wireless modules. The wireless module is, for example, a network interface card (NIC). Hereinafter, the wireless module included in the base station 10 is referred to as a “first wireless module,” and the wireless module included in the wireless terminal 20 is referred to as a “second wireless module.”

In the example shown in FIG. 1, the base station 10 includes a plurality of NICs as first wireless modules. Here, branch numbers such as “NIC-i” are used to distinguish a plurality of NICs. In addition, N is an integer equal to or greater than 2. For example, N is 2. A plurality of NIC-1 to NIC-N are set to perform wireless communication using different channels CH-1 to CH-N that do not overlap each other. Thus, by switching the use states of the plurality of NIC-1 to NIC-N, channels used in wireless communication by the base station 10 can be switched. For example, by switching NICs used among the plurality of NIC-1 to NIC-N, channels used in wireless communication by the base station 10 can be switched. As such, a process of switching channels used in wireless communication by the base station 10 is hereinafter referred to as a “channel switching process.”

Here, an NIC which is selectively used among the plurality of NIC-1 to NIC-N is hereinafter referred to as a “selected NIC.” The “selected NIC” can also be paraphrased as a “used NIC,” an “active NIC,” or the like. The channel switching process can also be said to be an “NIC switching process” of switching the selected NIC among the plurality of NIC-1 to NIC-N.

In the example shown in FIG. 1, each of the plurality of wireless terminals 20 includes one NIC as a second wireless module. The NIC included in each of the plurality of wireless terminals 20 is set to perform wireless communication using any one of channels CH-1 to CH-N. However, the channels for performing wireless communication among the plurality of wireless terminals 20 may be set to be different. For example, in FIG. 1, the NIC included in each of the wireless terminals 20 may be set so that the wireless terminals 20 indicated as STA #1 and STA #2 perform wireless communication using the channel CH-1 and the wireless terminal 20 indicated as STA #3 performs wireless communication using the channel CH-2.

Hereinafter, a channel for performing wireless communication for each of the plurality of wireless terminals 20 is referred to as a “communication channel.” In the above example, the communication channel of the wireless terminals 20 indicated as STA #1 and STA #2 is the channel CH-1, and the communication channel of the wireless terminal 20 indicated as STA #3 is the channel CH-2.

Incidentally, it can be considered that the base station 10 and the plurality of wireless terminals 20 constitute a plurality of BSSs that perform wireless communication using different channels CH-1 to CH-N that do not overlap each other. That is, for each of the channels CH-1 to CH-N, N BSSs composed of the base station 10 and the wireless terminal 20 that performs wireless communication using the channel CH-i can be considered. In addition, when considered as such, the base station 10 can be considered to function as N access points using the plurality of NIC-1 to NIC-N.

Hereinafter, the BSS that performs wireless communication using the channel CH-i is referred to as “BSS-i,” and a group of the wireless terminals 20 constituting BSS-i is referred to as “STAs-i.” That is, the communication channel of the wireless terminal 20 included in STAs-i is the channel CH-i. In addition, when the base station 10 is considered to function as N access points, the access point realized by the NIC-i is referred to as “AP-i.” That is, the BSS-i is composed of the AP-i and the STAs-i.

Meanwhile, each of the plurality of wireless terminals 20 may be capable of switching communication channels. That is, each of the plurality of wireless terminals 20 can switch the AP-i serving as a connection destination, and may not be fixed to a specific communication channel.

The wireless communication system 1 according to the first embodiment further includes a control device 100 that controls the base station 10. In particular, the control device 100 manages and controls the channel switching process (NIC switching process).

In the example shown in FIG. 1, the control device 100 is connected to the base station 10. However, the control device 100 does not necessarily have to be connected to the outside of the base station 10. The function of the control device 100 may be included in the base station 10. For example, the function of the control device 100 is realized by the base station 10 executing a control program. In that case, the base station 10 itself that executes the control program functions as the control device 100.

In the following description, the control device 100 that manages and controls the channel switching process and the control program are collectively referred to as the “control device 100” or “control function.”

The control device 100 (control function) according to the first embodiment executes the channel switching process of switching the use states of the plurality of NIC-1 to NIC-N. Particularly, in the channel switching process, the control device 100 (control function) switches the use states of the plurality of NIC-1 to NIC-N according to a predetermined schedule so as to enable any one of the plurality of NIC-1 to NIC-N to carry out transmission and to prohibit the other thereof from carrying out transmission.

Here, the schedule is information that provides transmission—enabled periods and transmission-prohibited periods for each of the plurality of NIC-1 to NIC-N. However, the transmission-enabled periods are provided so as not to overlap each other among the plurality of NIC-1 to NIC-N. The schedule may be information that provides one cycle of transmission-enabled period and transmission-prohibited period for each of the plurality of NIC-1 to NIC-N. In this case, the use states of the plurality of NIC-1 to NIC-N due to the channel switching process are periodically repeated in accordance with the schedule.

In addition, the schedule may be given in advance as a control program, or may be given as appropriate in accordance with the communication environment. For example, the control device 100 (control function) may give a schedule on the basis of the number of connected wireless terminals 20 and traffic information. For example, a schedule may be given such that the transmission-enabled period of each of the plurality of NIC-1 to NIC-N in one cycle is the ratio of the number of wireless terminals 20 connected to each of the plurality of NIC-1 to NIC-N, or the ratio of the traffic amount of the corresponding channels CH-1 to CH-N.

Further, the priority of traffic of the corresponding channels CH-1 to CH-N may be acquired, and a schedule may be given so that the transmission-enabled period of the NIC-i corresponding to a channel CH-i with high priority becomes longer.

In the transmission-prohibited period, data reception is possible but data transmission is prohibited. As a modification example, only the transmission of a specific wireless frame (example: a response frame (ACK) responding to the reception of an uplink frame) may be allowed even in the transmission-prohibited period.

The base station 10 according to the first embodiment acquires the schedule from the control device 100 and notifies the plurality of wireless terminals 20 of the schedule. Here, the schedule is typically notified of as data transmission through wireless communication. In this case, it is desirable that the plurality of NIC-1 to NIC-N be configured such that data transmission related to the schedule notification is allowed even in the transmission-prohibited period. In addition, it is desirable that the schedule be notified of before wireless communication with the plurality of wireless terminals 20 is started. However, in a case where the schedule is changed, the schedule may be notified of each time.

Each of the plurality of wireless terminals 20 according to the first embodiment is configured to sleep the operation of the NIC (second wireless module) while the NIC-i (first wireless module) that performs wireless communication using the communication channel CH-i is prohibited from carrying out transmission in the schedule. This can be realized by each of the plurality of wireless terminals 20 supporting standard technology such as a target wake time (TWT).

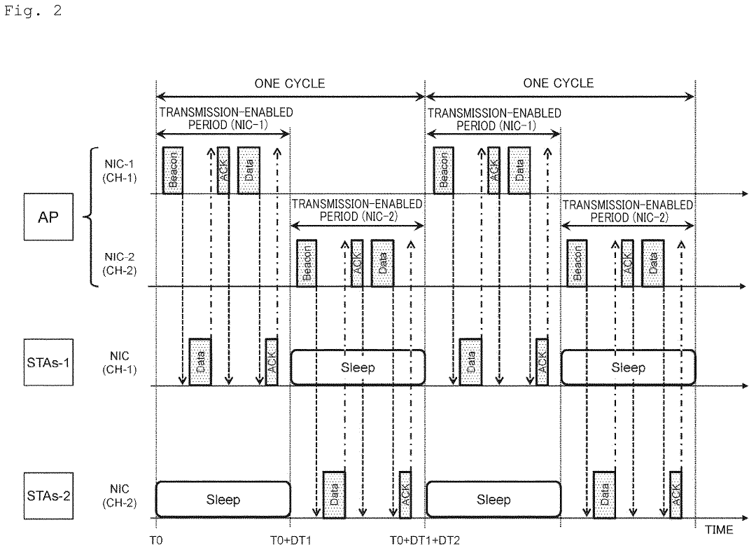

FIG. 2 is a conceptual diagram illustrating an example of wireless communication using a wireless communication method realized by the wireless communication system 1 according to the first embodiment. FIG. 2 shows a case where the base station 10 includes an NIC-1 that performs wireless communication using the channel CH-1 and an NIC-2 that performs wireless communication using the channel CH-2 as the first wireless modules. Therefore, the plurality of wireless terminals 20 are classified into a group STAs-1 in which the communication channel of the NIC provided as the second wireless module is CH-1 and a group STAs-2 in which the communication channel is CH-2.

In the example shown in FIG. 2, transmission and reception of data for a period of two cycles are shown in a case where a schedule of one cycle is given. Here, the schedule is given so that the period from point in time TO at the start of one cycle to point in time T0+DT1 after time DT1 has elapsed is the transmission-enabled period of the NIC-1 and that the period from point in time T0+DT1 at the end of the transmission-enabled period of the NIC-1 to point in time T0+DT1+DT2 after time DT2 has elapsed is the transmission-enabled period of the NIC-2. Meanwhile, the NIC-2 is in the transmission-prohibited period while the NIC-1 is in the transmission-enabled period, and the NIC-1 is in the transmission-prohibited period while the NIC-2 is in the transmission-enabled period.

Therefore, as shown in FIG. 2, each of the wireless terminals 20 included in the STAs-1 performs wireless communication (reception of a beacon, transmission/reception of data, and transmission/reception of a response frame (ACK)) with the base station 10 during the transmission-enabled period of the NIC-1, while the NIC operation is slept during the period from T0+DT1 to T0+DT1+DT2, which is the transmission-enabled period of the NIC-2 (the transmission-prohibited period of the NIC-1).

In addition, each of the wireless terminals 20 included in the STAs-2 performs wireless communication with the base station 10 during the transmission-enabled period of the NIC-2, while the NIC operation is slept during the period from TO to T0+DT1, which is the transmission-enabled period of the NIC-1 (the transmission-prohibited period of the NIC-2).

Meanwhile, the base station 10 is configured such that the transmission time per unit time of each of the plurality of NIC-1 to NIC-N(first wireless modules) is equal to or less than a first predetermined time, and that the total transmission time per unit time of each of the plurality of NIC-1 to NIC-N(first wireless modules) is equal to or less than a second predetermined time. For example, the unit time is one hour, the first predetermined time is 360 seconds, and the second predetermined time is 720 seconds. This may be realized by the control function (control program) of the control device 100 or the base station 10. By configuring the base station 10 in this way, it is possible to cope with the limit of the total transmission time for the base station 10.

Similarly, each of the plurality of wireless terminals 20 is configured such that the transmission time per unit time of the NIC (second wireless module) is equal to or less than the first predetermined time. This may be realized by the control function (control program) of each of the plurality of wireless terminals 20. By configuring each of the plurality of wireless terminals 20 in this way, it is possible to cope with the limit of the total transmission time for each of the plurality of wireless terminals 20.

As described above, according to the first embodiment, the base station 10 includes the plurality of NIC-1 to NIC-N (first wireless modules) that perform wireless communication using different channels that do not overlap each other. In addition, each of the plurality of wireless terminals 20 that form a wireless communication network with the base station 10 includes an NIC (second wireless module) that performs wireless communication using any one of the communication channels CH-1 to CH-N. The control device 100 executes the channel switching process of switching the use states of the plurality of NIC-1 to NIC-N according to a predetermined schedule so as to enable any one of the plurality of NIC-1 to NIC-N to carry out transmission and to prohibit the other thereof from carrying out transmission. Each of the plurality of wireless terminals 20 is configured to sleep the operation of the NIC (second wireless module) while the NIC-i (first wireless module) performs wireless communication using the communication channel CH-i is prohibited from carrying out transmission in the schedule.

This makes it possible to switch transmission from the base station 10 to the wireless terminal 20 among the plurality of channels CH-1 to CH-N and to reduce the total transmission time for downlink traffic. Meanwhile, when a schedule is given so that switching is frequently performed, it is also possible to sufficiently reduce delays in downlink and uplink traffic associated with switching.

Incidentally, as a technique of reducing the total transmission time, it can be conventionally considered that each of the plurality of wireless terminals 20 includes a plurality of NICs which are set to perform wireless communication using a plurality of channels CH-1 to CH-N as in the base station 10, and that the base station 10 and the plurality of wireless terminals 20 are synchronized to switch the channel CH-i for performing wireless communication. That is, it is a method of performing the channel switching process in one BSS composed of the base station 10 and the plurality of wireless terminals 20.

With this technique, channels are switched in each of the plurality of wireless terminals 20, and thus it is also possible to reduce the total transmission time of not only downlink traffic but also uplink traffic. However, downlink traffic usually increases with an increase in the number of wireless terminals 20 to be connected to the base station 10, while uplink traffic depends on the content of each communication. Therefore, in view of the problem of an increase in the total transmission time due to the large number of wireless terminals 20, there is little demand for reducing the total transmission time of uplink traffic, and it is sufficient insofar as the downlink traffic can be reduced.

In addition, the above technique requires an additional control device or control function for performing the channel switching process in each of the plurality of wireless terminals 20. This raises concern about feasibility due to control overhead and cost increase in a case where the number of the wireless terminal 20 is large.

Further, in the above technique, the channel switching process is performed in one BSS, and thus the number of wireless terminals 20 to be connected to the base station 10 does not change before and after channel switching. For this reason, in a case where the number of wireless terminals 20 is large, there may be concern of frame collisions among the plurality of wireless terminals 20 being likely to occur in the uplink traffic. Consequently, there may be concern of the capacity of the BSS decreasing.

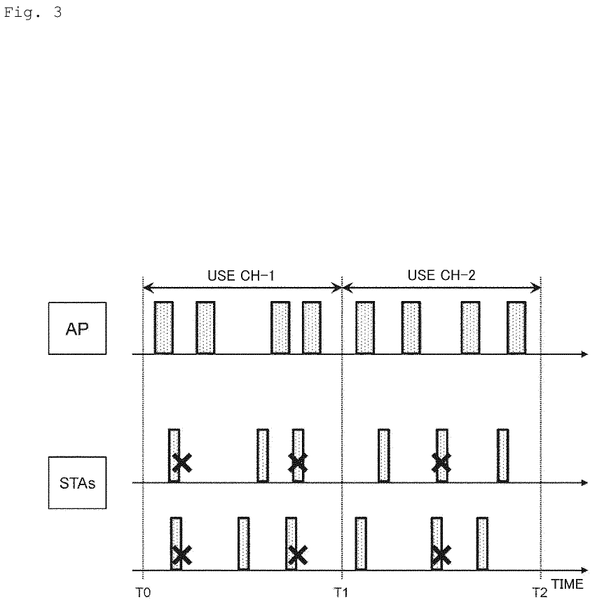

FIG. 3 is a diagram conceptually illustrating an example of frame collision. In the example shown in FIG. 3, the base station (AP) 10 and the plurality of wireless terminals (STAs) 20 constitute one BSS, where the channel CH-1 is used from TO to T1 and the channel CH-2 is used from T1 to T2. FIG. 3 shows a time series of frames transmitted by the base station 10 and a time series of frames transmitted by two wireless terminals 20 out of the plurality of wireless terminals 20. As shown in FIG. 3, a frame collision (x mark) occurs in a case where two wireless terminals 20 transmit frames at the same timing. Such a frame collision is more likely to occur in wireless communication or the like in which access is controlled by CSMA/CA when the number of wireless terminals 20 constituting one BSS increases.

As such, the above technique can reduce the total transmission time, but may not be efficient when the number of the wireless terminals 20 is large.

On the other hand, according to the first embodiment, as described above, it is possible to reduce the total transmission time for downlink traffic, and each of the plurality of wireless terminals 20 need only support standard technology (for example, TWT). Consequently, each of the plurality of wireless terminals 20 does not require an additional control device and control function. Naturally, by providing an additional control device and control function to each of the plurality of wireless terminals 20 includes, it is also possible to realize sleeping the operation of the second wireless module according to a schedule.

Further, according to the first embodiment, the plurality of wireless terminals 20 are distributed in a plurality of groups STAs-i that perform wireless communication using communication channels CH-i different from each other by means of the plurality of NIC-1 to NIC-N. This makes it possible to reduce frame collisions among uplink traffic of each of the plurality of wireless terminals 20. Consequently, it can be expected to improve the capacity of uplink traffic and expand the range of priority setting in which control is performed by giving relatively preferential treatment to the quality of communication (for example, delay and error rate).

In addition, according to the first embodiment, the transmission-enabled period do not overlap each other among the plurality of NIC-1 to NIC-N, and thus countermeasures against leakage power can be taken between corresponding channels CH-1 to CH-N. Consequently, the effect of reducing power consumption can be expected.

### 1-2. Configuration

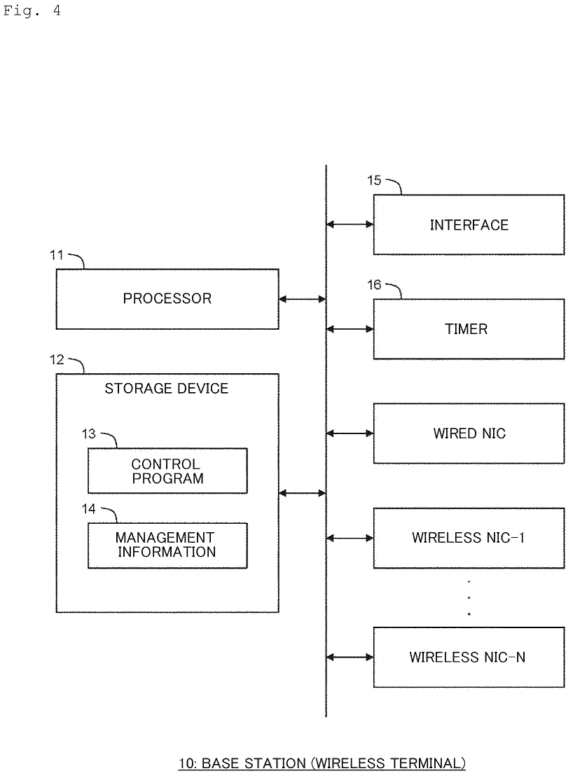

FIG. 4 is a block diagram illustrating a configuration of the base station 10 according to the first embodiment. The base station 10 includes one or a plurality of processors 11, one or a plurality of storage devices 12, a wired NIC, and a plurality of wireless NICs (NIC-1 to NIC-N).

The processor 11 performs various types of information processing. For example, the processor 11 includes a central processing unit (CPU). The storage device 12 stores various types of information necessary for processing performed by the processor 11. Examples of the storage device 12 include a volatile memory, a non-volatile memory, a hard disk drive (HDD), a solid state drive (SSD), and the like.

A control program 13 is a computer program executed by the processor 11 (computer). The function of the base station 10 is realized by the processor 11 executing the control program 13. The control program 13 is stored in the storage device 12. The control program 13 may be recorded in a computer readable recording medium. The control program 13 may be provided in the base station 10 through a network. Meanwhile, the processor 11 executing the control program 13 is equivalent to the control device 100 that controls the base station 10.

Management information 14 includes at least information used to manage and control the above-described channel switching process. For example, the management information 14 includes network identifiers (BSSIDs), channels, schedules, and the like for each NIC. The management information 14 may include the total transmission time for each NIC. The management information 14 is stored in the storage device 12.

Further, the base station 10 may include an interface 15 for external operation. For example, the interface 15 is connected to an external control device 100. The interface 15 may include a user interface.

Further, the base station 10 may include a timer 16 for managing a timing of switching of the channel switching process (NIC switching process).

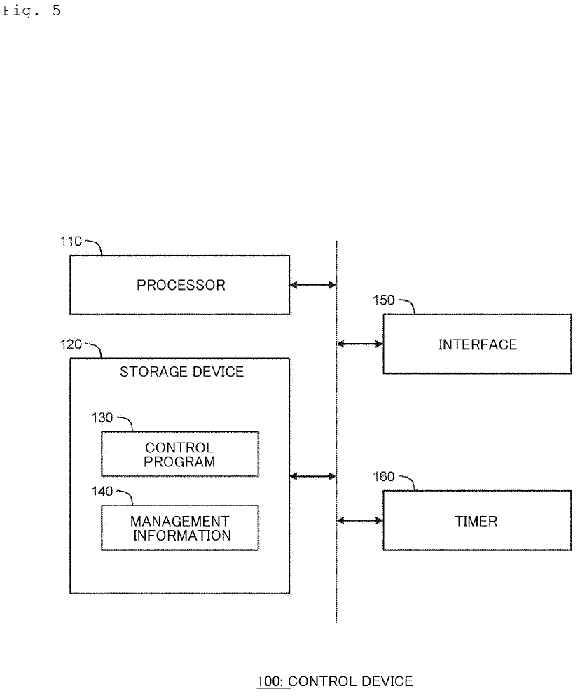

FIG. 5 is a block diagram illustrating a configuration example of the control device 100 according to the first embodiment. The control device 100 includes one or a plurality of processors 110 and one or a plurality of storage devices 120.

The processor 110 performs various types of information processing. For example, the processor 110 includes a CPU. The storage device 120 stores various types of information necessary for processing performed by the processor 110. Examples of the storage device 120 include a volatile memory, a non-volatile memory, an HDD, an SSD, and the like.

A control program 130 is a computer program executed by the processor 110 (computer). The function of the control device 100 is realized by the processor 110 executing the control program 130. The control program 130 is stored in the storage device 120. The control program 130 may be recorded in a computer readable recording medium. The control program 130 may be provided in the control device 100 through a network.

Management information 140 includes information used to manage and control the above-described channel switching process. For example, the management information 140 includes network identifiers (BSSIDs), channels, schedules, and the like for each NIC. The management information 140 may include the total transmission time for each NIC. The management information 140 is stored in the storage device 120.

Further, the control device 100 may include an interface 150. For example, the interface 150 is connected to the base station 10. The interface 150 may include a user interface.

Further, the control device 100 may include a timer 160 for managing a timing of switching of the channel switching process (NIC switching process).

The configuration of the wireless terminal 20 according to the first embodiment may be the same as the configuration of the base station 10 shown in FIG. 4. However, the wireless terminal 20 has one wireless NIC.

1-3. Connection Destination Control

According to the wireless communication system 1 of the first embodiment, the base station 10 and the plurality of wireless terminals 20 constitute a plurality of BSS-1 to BSS-N that perform wireless communication using different channels CH-1 to CH-N that do not overlap each other, and the channel switching process is performed in the base station 10, which makes it possible to reduce the total transmission time for downlink traffic. Here, as described above, the plurality of wireless terminals 20 are grouped into a plurality of groups STAs-1 to STAs-N constituting a plurality of BSS-1 to BSS-N, respectively.

Incidentally, it is assumed that the content of grouping of the plurality of wireless terminals 20 significantly influences traffic on each of the plurality of channels CH-1 to CH-N. For example, when the group STAs-1 and the group STAs-2 are compared with each other, it is assumed that the traffic amount of the channel CH-1 becomes larger than the traffic amount of the channel CH-2 in a case where the number of wireless terminals 20 included in the group STAs-1 is large, a case where the frequency of transmission and reception is high, a case where the amount of data to be transmitted and received is large, or the like. In this case, a situation may arise in which the BSS-1 immediately reaches the limit of the total transmission time, while the BSS-2 has enough time for the total transmission time.

Consequently, in the wireless communication system 1 according to the first embodiment, connection destination control is performed to control connection between the base station 10 and the plurality of wireless terminals 20 so that the plurality of wireless terminals 20 are appropriately grouped on the basis of traffic information. This makes it possible to more effectively reduce the total transmission time. The connection destination control is realized by processing being executed by the control device 100, the control function (control program) of the base station 10, or the control function (control program) of the wireless terminal 20.

Hereinafter, various examples of the connection destination control performed in the wireless communication system 1 according to the first embodiment will be described. Here, duplicated content in each description will be omitted as appropriate.

### 1-3-1. First Example

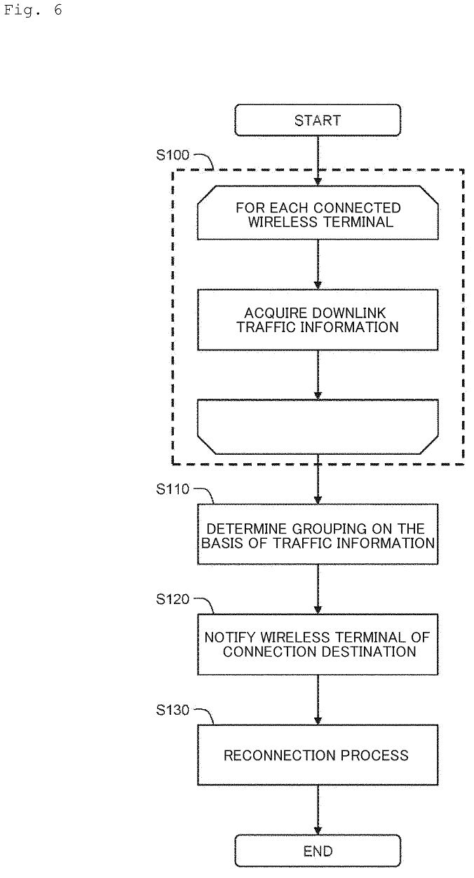

In a first example of the connection destination control, the base station 10 collectively designates connection destinations. FIG. 6 is a flowchart illustrating processing executed in the first example of the connection destination control. The flowchart shown in FIG. 6 may be repeatedly executed at each predetermined period, or may be started under predetermined conditions. For example, it may be started on condition that the total transmission time of a certain BSS-i reaches a limit.

In step S100, the base station 10 acquires downlink traffic information for each of the plurality of connected wireless terminals 20. The traffic information to be acquired includes, for example, a traffic information map (TIM), a traffic type, priority, and the like. In step S100, the base station 10 may further acquire information on uplink traffic.

In step S110, the base station 10 determines grouping of the plurality of wireless terminals 20 on the basis of the traffic information acquired in step S100. For example, grouping is determined so that the amounts of downlink traffic of the plurality of channels CH-1 to CH-N are uniform. Alternatively, from the traffic type, grouping is determined so that the STAs-1 connected to AP-1 (NIC-1) is composed of the wireless terminals 20 that transmit and receive sensor-based data, and the STAs-2 connected to AP-2 (NIC-2) is composed of the wireless terminals 20 that transmit and receive video-based data. In this case, when it is determined that the quality of communication cannot be maintained due to the congestion of communication with AP-2 (NIC-2) (for example, when the upper limit of the number of connected wireless terminals 20 or the upper limit of traffic amount set in advance is exceeded), grouping may be performed such that the wireless terminals 20 that transmit and receive sensor-based data are included in the STAs-1. Further, the wireless terminals 20 connected to the base station 10 may be grouped so as to be limited the wireless terminals 20 that transmit and receive data with high priority. In this case, there may be wireless terminals 20 which are not included in any of a plurality of groups STAs-1 to STAS-N.

In step S120, the base station 10 notifies each of the plurality of wireless terminals 20 of a connection destination in accordance with the grouping determined in step S110. The connection destination may be notified of by a notification frame (for example, a beacon frame) transmitted by the base station 10, or may be individually notified of by transmitting a specific frame or the like. In addition, in step S120, the base station 10 may notify of the schedule together with the notification of the connection destination.

In step S130, the base station 10 and the plurality of wireless terminals 20 execute a reconnection process. This makes it possible to realizes a plurality of BSS-1 to BSS-N according to the grouping determined in step S110. Meanwhile, the reconnection process may be realized by a standard function of a known wireless module.

### 1-3-2. Second Example

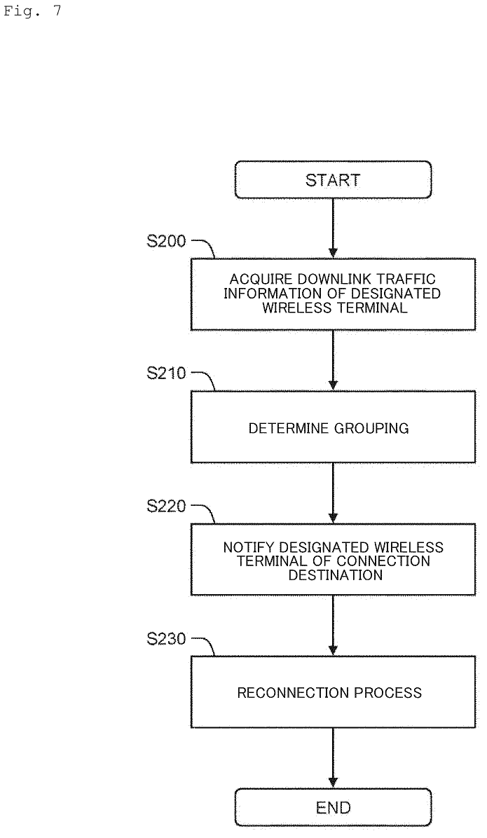

In a second example of connection destination control, the base station 10 designates a connection destination for each of the plurality of wireless terminals 20. FIG. 7 is a flowchart illustrating processing executed in a second example of connection destination control. The flowchart shown in FIG. 7 is executed by designating any one of the plurality of wireless terminals 20. Here, the flowchart shown in FIG. 7 may be sequentially executed at each predetermined period for each of the plurality of wireless terminals 20, or may be executed by designating the wireless terminal 20 that satisfies a predetermined condition. For example, it may be executed by designating the wireless terminal 20 with a change in the type or amount of data to be transmitted and received.

In step S200, the base station 10 acquires downlink traffic information for the designated wireless terminals 20. The base station 10 may further acquire uplink traffic information.

In step S210, the base station 10 determines grouping of the designated wireless terminals 20 on the basis of the traffic information acquired in step S100.

In step S220, the base station 10 notifies the designated wireless terminals 20 of the connection destination in accordance with the group determined in step S210. The base station 10 may notify of the schedule together with the notification of the connection destination.

In step S230, the base station 10 and the designated wireless terminals 20 execute the reconnection process. This makes it possible to realize a plurality of BSS-1 to BSS-N according to the grouping determined in step S110.

### 1-3-3. Third Example

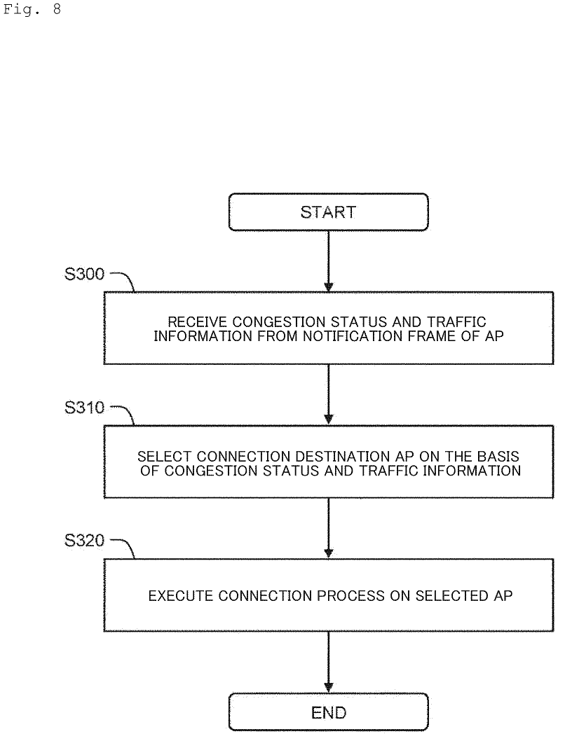

In a third example of connection destination control, each of the plurality of wireless terminals 20 designates a connection destination. FIG. 8 is a flowchart illustrating processing executed in a third example of connection destination control. The flowchart shown in FIG. 8 may be repeatedly executed at each predetermined period in each of the plurality of wireless terminals 20, or may be started in the wireless terminal 20 that satisfies a predetermined condition. For example, it may be started in the wireless terminal 20 with a change in the type or amount of data to be transmitted and received.

In step S300, the wireless terminal 20 receives the congestion status (for example, the number of wireless terminals 20 to be connected or the number of packets transmitted and received) and traffic information (for example, traffic type or priority) of a plurality of BSS-1 to BSS-N from notification frames (such as, for example, a beacon frame and a probe response frame) of each of the plurality of AP-1 to AP-N.

In step S310, the wireless terminal 20 selects the AP-i which is a connection destination on the basis of the congestion status and traffic information received in step S300. For example, from the congestion status, the AP-i of BSS-i with the least congestion (for example, the fewest number of wireless terminals 20 to be connected, or the fewest number of packets to be transmitted and received during the transmission-enabled period) is selected as the connection destination. Further, the connection destination AP-i may be selected from the traffic type. For example, the connection destination AP-i is selected so that the BSS-1 transmits and receives sensor-based data, and that the BSS-2 transmits and receives video-based data. In addition, the AP-i that can be connected may be limited from the priority. For example, the AP-2 is configured to be connectable only to the wireless terminals 20 with a certain level of priority or higher.

In step S320, the wireless terminal 20 executes a connection process on the AP-i selected in step S310. The connection process may be realized by a standard function of a known wireless module. The flowchart shown in FIG. 8 is executed in each of the plurality of wireless terminals 20 to realize grouping of the plurality of wireless terminals 20 based on the congestion status and traffic information.

### 1-3-4. Fourth Example

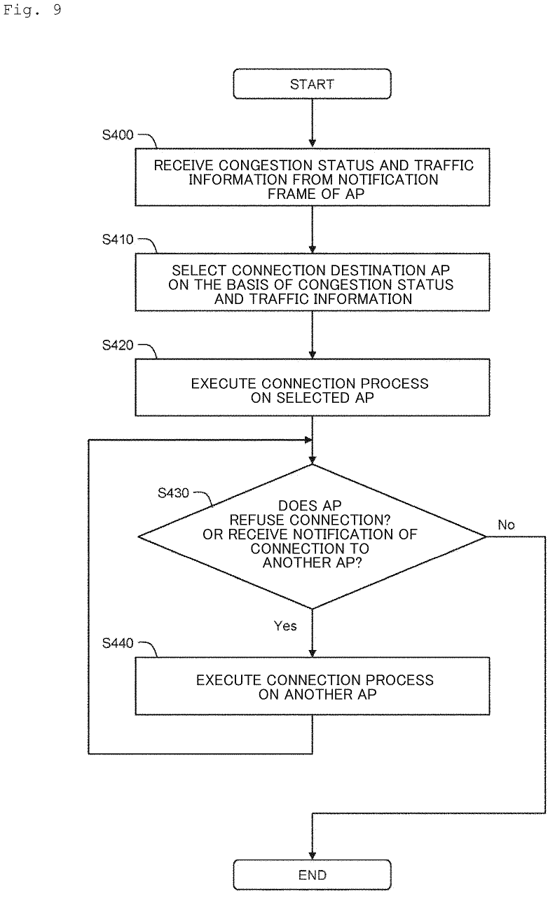

In a fourth example of connection destination control, each of the plurality of wireless terminals 20 designates a connection destination, and then the base station 10 determines whether to permit or refuse the connection. FIG. 9 is a flowchart illustrating processing executed in a fourth example of connection destination control. The flowchart shown in FIG. 9 may be repeatedly executed at each predetermined period, or may be started under a predetermined condition.

In step S400, the wireless terminal 20 receives the congestion status and traffic information of the plurality of BSS-1 to BSS-N from the notification frame each of the plurality of AP-1 to AP-N.

In step S410, the wireless terminal 20 selects the connection destination AP-i on the basis of the congestion status and traffic information received in step S400.

In step S420, the wireless terminal 20 executes the connection process on the AP-i selected in step S410.

In step S430, the wireless terminal 20 determines whether the connection destination AP-i has refused connection with respect to the connection process executed in step S420, or whether a notification of connection to another AP-i has been received. Here, the connection destination AP-i is configured to refuse connection to the wireless terminal 20 or transmit a notification of connection to another AP-i in a case where the number of wireless terminals 20 to be connected cannot be increased (for example, in a case where the number of connected wireless terminals 20 exceeds an expected value). Meanwhile, the wireless terminal 20 may be configured to receive a notification of connection to another AP-i from the connected AP-i after connection to the AP-i through the connection process executed in step S420.

In a case where the connection destination AP-i refuses connection with respect to the connection process executed in step S420, or a case where a notification of connection to another AP-i is received (step S430; Yes), the wireless terminal 20 executes the connection process on another AP-i (step S440). Here, in a case where a notification of connection to another AP-i is received in step S430, the wireless terminal 20 executes the connection process on the AP-i designated in the connection notification. After step S440, the process proceeds to step S430 again.

The flowchart shown in FIG. 9 is executed in each of the plurality of wireless terminals 20 and the connection process executed in step S420 or step S440 is normally completed (step S430; No), to thereby realize grouping of the plurality of wireless terminals 20 based on the congestion status and traffic information.

### 1-4. Modification Example

The wireless communication system 1 according to the first embodiment may adopt the following modified aspects.

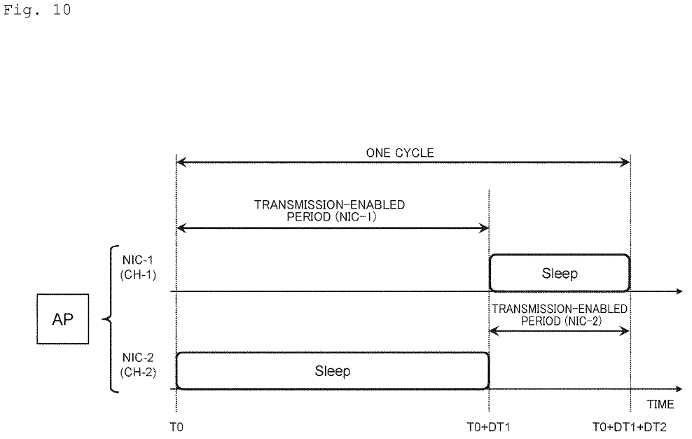

The base station 10 may be configured to sleep the operation of the NIC-i during the transmission-prohibited period. FIG. 10 is a conceptual diagram illustrating an example of operations of the first wireless modules (NIC-1 and NIC-2) in a base station (AP) 10 according to a modification example. FIG. 10 shows a case where the base station 10 includes an NIC-1 that performs wireless communication using the channel CH-1 and an NIC-2 that performs wireless communication using the channel CH-2 as the first wireless modules.

As shown in FIG. 10, in the base station 10 according to the modification example, the operation of the NIC-1 is slept during the period from T0 to T0+DT1, which is the transmission-prohibited period of the NIC-2 (the transmission-enabled period of the NIC-1). In addition, the operation of the NIC-2 is slept during the period from T0+DT1 to T0+DT1 +DT2, which is the transmission-prohibited period of the NIC-1 (the transmission-enabled period of the NIC-2).

Power consumption can be reduced in the base station 10 by adopting such a modified aspect. Meanwhile, the base station according to the modification example is realized by using, for example, Implicite TWT of IEEE 802.11ah.

### 2. Second Embodiment

A second embodiment will be described below. The content that overlaps with the first embodiment will be omitted as appropriate, and differences from the first embodiment will be described in particular detail.

### 2-1. Overview

The configuration of a wireless communication system 1 according to a second embodiment may be the same as the configuration of the wireless communication system 1 according to the first embodiment shown in FIG. 1. That is, the wireless communication system 1 includes a base station (AP) 10, a plurality of wireless terminals (STA) 20 that form a wireless communication network with the base station 10, and a control device 100 that controls the base station 10. In addition, the base station 10 includes a plurality of NIC-1 to NIC-N as first wireless modules, and each of the plurality of wireless terminals 20 includes one NIC as a second wireless module.

The control device 100 (control function) executes the channel switching process of switching the use states of the plurality of NIC-1 to NIC-N according to a predetermined schedule so as to enable any one of the plurality of NIC-1 to NIC-N to carry out transmission and to prohibit the other thereof from carrying out transmission.

Each of the plurality of wireless terminals 20 according to the second embodiment does not sleep the operation of the NIC (second wireless module). That is, the operation of the NIC (second wireless module) is continued even while the NIC-i that performs wireless communication using the communication channel CH-i is prohibited from carrying out transmission in the schedule. On the other hand, each of the plurality of wireless terminals 20 according to the second embodiment is configured not to request a response frame from the base station 10 during the frame transmission (or not to transmit a frame requiring a response frame). For example, an ACK policy is set to “No ACK” for each of the plurality of wireless terminals 20. Alternatively, an RTS threshold is set to be high so as not to substantially perform RTS transmission. These can be realized by standard functions of the wireless modules.

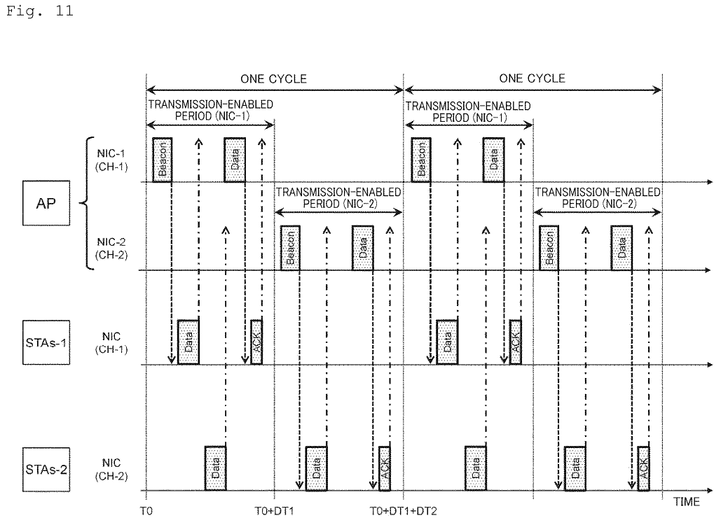

FIG. 11 is a conceptual diagram illustrating an example of wireless communication using a wireless communication method realized by the wireless communication system 1 according to the second embodiment. FIG. 11 shows the same situation as in FIG. 2.

As shown in FIG. 11, in the wireless communication system 1 according to the second embodiment, each of the wireless terminals 20 included in the STAs-1 continues the operation of the NIC even during the period from T0+DT to T0+DT1+DT2, which is the transmission-prohibited period of the NIC-1. Similarly, each of the wireless terminals 20 included in the STAs-2 continues the operation of the NIC even during the period from TO to T0+DT1, which is the transmission-prohibited period of the NIC-2.

On the other hand, as shown in FIG. 11, in the wireless communication system 1 according to the second embodiment, the base station (AP) 10 does not transmit a response frame even if data is received from the STAs-1 and the STAs-2. That is, even if the STAs-1 and the STAs-2 continue the operation of the NIC during the transmission-prohibited period of the NIC-1 or the NIC-2, downlink traffic will not increase. Consequently, as in the wireless communication system 1 according to the first embodiment, it is possible to reduce the total transmission time for a downlink frame. Further, wireless communication can be continued during the transmission-prohibited period of the NIC-1 or the NIC-2.

Meanwhile, for data transmitted by the wireless terminal 20, a downlink data packet loss can be detected by using a response frame of an upper layer such as TCP-ACK.

In addition, as in the first embodiment, the base station 10 may be configured such that the transmission time per unit time of each of the plurality of NIC-1 to NIC-N(first wireless modules) is equal to or less than a first predetermined time, and that the total transmission time per unit time of each of the plurality of NIC-1 to NIC-N(first wireless modules) is equal to or less than a second predetermined time. Each of the plurality of wireless terminals 20 may be configured such that the transmission time per unit time of the NIC (second wireless module) is equal to or less than a first predetermined time. This makes it possible to cope with the limit of the total transmission time for the base station 10 and each of the plurality of wireless terminals 20.

As described above, according to the second embodiment, the base station 10 includes a plurality of NIC-1 to NIC-N(first wireless modules) that perform wireless communication using different channels that do not overlap each other. In addition, each of the plurality of wireless terminals 20 that form a wireless communication network with the base station 10 includes an NIC (second wireless module) that performs wireless communication using any one of the communication channels CH-1 to CH-N. The control device 100 executes the channel switching process of switching the use states of the plurality of NIC-1 to NIC-N according to a predetermined schedule so as to enable any one of the plurality of NIC-1 to NIC-N to carry out transmission and to prohibit the other thereof from carrying out transmission. Each of the plurality of wireless terminals 20 is configured not to request a response frame from the base station 10 during frame transmission (or not to transmit a frame requiring a response frame).

As in the first embodiment, this makes it possible to reduce the total transmission time for downlink traffic. In particularly, each of the plurality of wireless terminals 20 does not require an additional control device and control function. Further, each of the plurality of wireless terminals 20 can continue wireless communication without increasing downlink traffic even when the NIC-i corresponding to the communication channel is in the transmission-prohibited period.

In addition, according to the second embodiment, as in the first embodiment, it is possible to reduce frame collisions between uplink traffic of each of the plurality of wireless terminals 20. Consequently, it can be expected to improve the capacity of uplink traffic and expand the range of priority setting in which control is performed by giving relatively preferential treatment to the quality of communication (for example, delay and error rate).

In addition, according to the second embodiment, as in the first embodiment, the transmission-enabled period do not overlap each other among the plurality of NIC-1 to NIC-N, and thus countermeasures against leakage power can be taken between corresponding channels CH-1 to CH-N. Consequently, the effect of reducing power consumption can be expected.

2-2. Configuration In second embodiment, the base station 10, the wireless terminal 20, and the control device 100 may be the same as in the first embodiment. That is, the configurations shown in FIGS. 4 and 5 may be used.

### 2-3. Connection Destination Control

In the wireless communication system 1 according to the second embodiment, connection destination control may be performed as in the first embodiment. In this case, in the second embodiment, the same effect as in the first embodiment can also be achieved by applying the connection destination control described in the first embodiment.

### 2-4. Modification Example

The wireless communication system 1 according to the second embodiment may adopt the following modified aspects.

2-4-1. Modification example 1 Each of the plurality of wireless terminals 20 may be configured to be able to request a response frame from the base station 10 during frame transmission while the NIC-i (first wireless module) that performs wireless communication using the communication channel CH-i is able to carry out transmission in the schedule. For example, each of the plurality of wireless terminals 20 changes an ACK policy to remove “No ACK” while the NIC-i that performs wireless communication using the communication channel CH-i is in the transmission-enabled period in the schedule. Alternatively, an RTS threshold is changed to perform RTS transmission.

By adopting such a modified aspect, a downlink data packet loss can be detected without using a response frame of an upper layer such as TCP-ACK while the NIC-i that performs wireless communication using the communication channel CH-i is in the transmission-enabled period in the schedule.

Consequently, it is possible to suppress an increase in delay until retransmission when a data packet loss occurs.

### 2-4-2. Modification Example 2

The plurality of wireless terminals 20 may include wireless terminals 20 capable of switching communication channels in order to reduce the total transmission time.

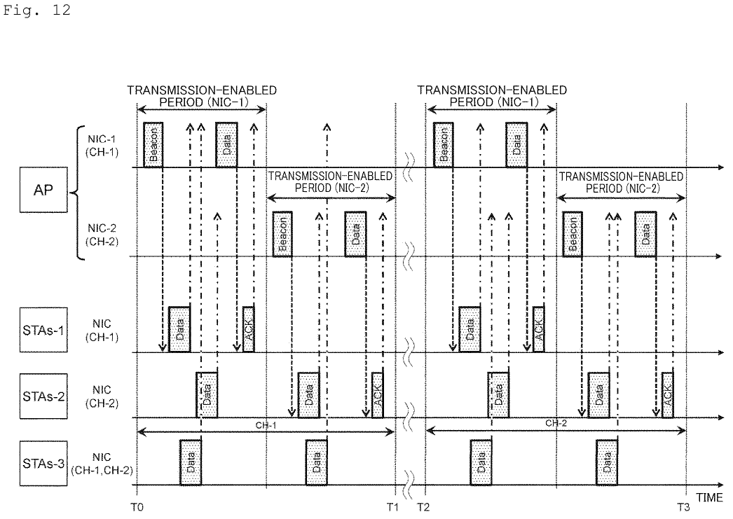

FIG. 12 is a conceptual diagram illustrating an example of wireless communication using a wireless communication method realized by a wireless communication system 1 according to Modification example 2. FIG. 12 shows a case where the base station 10 includes an NIC-1 that performs wireless communication using the channel CH-1 and an NIC-2 that performs wireless communication using the channel CH-2 as the first wireless modules.

The wireless communication system 1 according to Modification example 2 is characterized by including a wireless terminal 20 capable of switching communication channels. That is, in FIG. 12, the plurality of wireless terminals 20 are classified into a group STAs-1 in which the communication channel of the NIC provided as a second wireless module is CH-1, a group STAs-2 in which the communication channel is CH-2, and a group STAs-3 that can switch communication channels between CH-1 and CH-2.

The operations of STAs-1 and STAs-2 are the same as in the case shown in FIG. 11. The STAs-3 uses CH-1 as the communication channel during the period from TO to T1 and operates in the same way as STAs-1. On the other hand, it uses CH-2 as the communication channel during the period from T2 to T3 and operates in the same way as STAs-2. That is, each of the wireless terminals 20 included in the STAs-3 can switch between CH-1 and CH-2 to transmit data. Consequently, each of the wireless terminals 20 included in the STAs-3 can reduce the total transmission time.

Meanwhile, switching of the communication channels of the STAs-3 may be performed in synchronization with the channel switching process in the base station 10. In this case, each of the wireless terminals 20 included in the STAs-3 may be configured to be able to request a response frame from the base station 10 during frame transmission.

By adopting such a modified aspect, it is also possible to reduce the total transmission time in the plurality of wireless terminals 20.

### REFERENCE SIGNS LIST

1 Wireless communication system
10 Base station (AP)
11 Processor
12 Storage device
13 Control program
14 Management information
15 Interface
16 Timer
20 Wireless terminal (STA)
100 Control device
110 Processor
120 Storage device
130 Control program
140 Management information
150 Interface
160 Timer
CH-1 Channel
NIC-i Network interface card (first wireless module) NIC Network interface card (second wireless module)

1. A wireless communication method between a base station and a plurality of wireless terminals forming a wireless communication network with the base station,
wherein the base station includes a plurality of first wireless circuitries that perform wireless communication using different channels that do not overlap each other,
each of the plurality of wireless terminals includes a second wireless circuitry that performs wireless communication using any one of the communication channels, and
the wireless communication method comprises:
executing a channel switching process of switching use states of the plurality of first wireless circuitries according to a predetermined schedule so as to enable any one of the plurality of first wireless circuitries to carry out transmission and to prohibit the other thereof from carrying out transmission; and
sleeping an operation of the second wireless circuitry while the first wireless circuitry that performs wireless communication using the communication channel is prohibited from carrying out transmission in the schedule for each of the plurality of wireless terminals.

2. The wireless communication method according to claim 1, wherein;
the schedule is information that provides a transmission-enabled period and a transmission-prohibited period for each of the plurality of first wireless circuitries, and
the wireless communication method further comprises providing the transmission-enabled period and the transmission-prohibited period in the schedule on the basis of the number of wireless terminals connected to each of the plurality of first wireless circuitries or traffic information of the channel.

3. The wireless communication method according to claim 1, further comprising:
determining the communication channel of each of the plurality of wireless terminals on the basis of traffic information of the channel and executing connection destination control for controlling connection between the base station and the plurality of wireless terminals.

4. A wireless communication method between a base station and a plurality of wireless terminals forming a wireless communication network with the base station,
wherein the base station includes a plurality of first wireless circuitries that perform wireless communication using different channels that do not overlap each other,
each of the plurality of wireless terminals includes a second wireless circuitry that performs wireless communication using any one of the communication channels, and
the wireless communication method comprises:
executing a channel switching process of switching use states of the plurality of first wireless circuitries according to a predetermined schedule so as to enable any one of the plurality of first wireless circuitries to carry out transmission and to prohibit the other thereof from carrying out transmission; and
causing each of the plurality of wireless terminals not to request a response frame from the base station during transmission of a frame.

5. The wireless communication method according to claim 4, further comprising:
enabling each of the plurality of wireless terminals to request the response frame from the base station during transmission of the frame while the first wireless circuitry that performs wireless communication using the communication channel is able to carry out transmission in the schedule.

6. A wireless communication system comprising:
a base station;
a plurality of wireless terminals configured to form a wireless communication network with the base station; and
a control device configured to control the base station,
wherein the base station includes a plurality of first wireless circuitries that perform wireless communication using different channels that do not overlap each other,
each of the plurality of wireless terminals includes a second wireless circuitry that performs wireless communication using any one of the communication channels,
the control device executes a channel switching process of switching use states of the plurality of first wireless circuitries according to a predetermined schedule so as to enable any one of the plurality of first wireless circuitries to carry out transmission and to prohibit the other thereof from carrying out transmission,
the base station notifies the plurality of wireless terminals of the schedule, and
each of the plurality of wireless terminals is configured to sleep an operation of the second wireless circuitry while the first wireless circuitry that performs wireless communication using the communication channel is prohibited from carrying out transmission in the schedule.

7. (canceled)

8. A non-transitory computer readable medium storing a program which is executed by a computer and causes the computer to execute the wireless communication method according to claim 1.
